(19) United States
(12) Patent Application Publication
(10) Pub. No.: US 2019/0024606 A1
(43) Pub. Date: Jan. 24, 2019

(54) Piston With a Low Overall Height

(71) Applicant: KS Kolbenschmidt GmbH, Neckarsulm (DE)

(72) Inventors: Eberhard Weiss, Langenbrettach (DE); Gerhard Luz, Nordheim (DE); Jochen Müller, Mahlerstraße (DE); Emmerich Ottliczky, Forchtenberg (DE)

(73) Assignees: KS Kolbenschmidt GmbH, Neckarsulm (DE); KS Kolbenschmidt GmbH, Neckarsulm (DE)

(21) Appl. No.: 15/755,239

(22) PCT Filed: Aug. 29, 2016
(86) PCT No.: PCT/EP2016/070324

§ 371 Date: Jul. 19, 2018

(30) Foreign Application Priority Data
Aug. 28, 2015 (DE) 10 2015 216 553.1

(51) Int. Cl. F02F 3/22; F02F 3/10; F02F 3/00; F02F 3/26

(52) U.S. Cl. CPC F02F 3/22; F02F 3/10; F02F 2003/0061; F02F 3/26; F02F 2200/04; F02F 3/003

(57) ABSTRACT

The invention relates to a piston for an internal combustion engine having an upper part integrally joined to a lower part having a shaft and at least one pin bore. The upper part including a combustion chamber bowl recess and a piston crown with a crown edge. At least one joint is arranged in the region of a ring zone and in an outer wall of the combustion bowl recess, and the ratio of piston compression height (h₁) and the diameter of the piston (d₁) is less than 0.53.

### TECHNICAL FIELD

The invention relates to a piston with a low overall height for internal combustion engines.

### BACKGROUND

WO 2014/159634 A1 discloses a finished piston part which is used to form a piston arrangement. A finished piston has a lower part, wherein the lower part has a shaft and contains a lower surface of a cooling duct. The lower part comprises a radially bowl-shaped inner surface. The finished piston arrangement further has an upper part with a radially outer bowl-shaped surface which can be joined together with the radially inner bowl-shaped surface. The upper part has a radially circumferential inner wall which comprises a radially inner surface. The radially inner wall has a surface which points radially inwards and which has a non-parallel angle to the radially inner bowl surface in the region where the radially inner bowl surface strikes a radially innermost edge of the radially inner connecting surface.

In the case of pistons for internal combustion engines, the so-called compression height is a characteristic variable, wherein the compression height corresponds to the distance between the axis of the piston pin and an upper edge of the piston. The overall height of an internal combustion engine is determined, among other things, by this compression height of the piston of the internal combustion engine. A further characteristic variable of a piston of an internal combustion engine which has influence on the overall height of the internal combustion engine is what is known as a combustion bowl depth of a combustion bowl formed in the region of the piston upper part. The combustion in the cylinder of the internal combustion engine in which the piston is used can be improved by means of relatively deep combustion bowls. The deeper the design of a combustion bowl, the higher the compression height and thus the overall height of the internal combustion engine. Moreover, in the case of pistons with a low overall height, an inflow or outflow of the mixture or gas in or out of the combustion chamber must also be ensured.

### SUMMARY

The object on which the invention is based is therefore to provide a piston, in particular a cooling duct piston which has a reduced weight in comparison to known pistons with a low overall height and enables an improved mixture or gas exchange.

According to the invention, it is provided that at least one joint is arranged in the region of a ring field and in an outer wall of the combustion bowl and the ratio of piston compression height and diameter of the piston is smaller than 0.53. The diameter of the piston is in particular the outer diameter of the piston which is ready for use, i.e. finished.

The joints thus lie in regions of the piston joined by material bonding, which joints require finishing. Above all weld beads can thus be removed in the course of this finishing in order to configure the ring field and/or the combustion bowl. A separate process step is not necessary. The necessary overall height of the piston is simultaneously reached while achieving the required strength. A piston which enables an optimized overall height of the intended internal combustion engine is advantageously provided as a result of this. This in turn reduces the installation space required by the internal combustion engine, for example, in vehicles. The piston according to the invention also enables the production of mass-optimized internal combustion engines. As a result of pistons with such a low compression height, material is saved in the production of the pistons and the weight of the finished piston is reduced. As a result of this, fuel consumption can in turn be reduced. In turn, new vehicle concepts can arise as a result of the optimized overall height of the internal combustion engine and the reduced installation space for the internal combustion engine as a result of this.

It is furthermore provided according to the invention that the location of the inner joint in the outer wall of the combustion bowl is provided above the finished combustion bowl base. The inner friction weld bead is thus removed during production of the combustion bowl. A further process step is not necessary.

It is furthermore provided according to the invention that at least one recess is provided in the piston crown of the piston. The risk of collision of movable parts within the cylinder is reduced by the at least one recess. For example, a valve can penetrate into the region of the recess without coming into contact with the piston which has at least one recess. Moreover, the cylinder head can also have inner contours which correspond with the at least one recess. Here, contact with rigid parts within the cylinder is prevented by the at least one recess in the piston. The contours in the cylinder head can serve, for example, to guide the mixture or the gas in or out of the combustion chamber.

It is furthermore provided according to the invention that the at least one recess has at least one clearance which passes at least partially through the crown edge of the piston crown. A maximum travel path for the piston in the cylinder is possible as a result of the recess. The piston can come close to the cylinder head in the region of the recesses without the risk of coming into contact with the valves. The mixture can enter unhindered into the combustion chamber. After combustion, the primarily gaseous mixture can leave the combustion chamber even in the case of the piston coming very close to the cylinder head.

It is furthermore provided according to the invention that the at least one clearance is configured in a circular segment shape. A connection from the recess up to the cylinder wall is created as a result of this. The recess assumes the form of the piston in its outer configuration.

It is furthermore provided according to the invention that the at least one recess forms at least one valve pocket. A valve pocket enables an opened valve to be received in the region of the piston crown when the piston comes close to the upper dead center. As a result of this, it is ensured that a piston with a low overall height can travel the largest possible travel path within the cylinder. The working stroke can thus be maximized with a low overall height. The energy obtained from the combustion can be efficiently converted into kinetic energy.

It is furthermore provided according to the invention that the distance between a line, the line between pressure side and counter-pressure side and the center point of the first valve pocket is larger than the distance between the line and the center point of the second valve pocket. As a result of this, a position of the valve pockets primarily in one half of the piston crown, as seen in top view, is enabled. It is thus furthermore ensured that sufficient material remains between the recesses or valve pockets in order not to weaken the piston crown.

It is furthermore provided according to the invention that the distance between a line, the line between pressure side and counter-pressure side and the center point of the first valve pocket is at least twice as large as the distance between the line and the center point of the second valve pocket. As a result of this, it is ensured that there is sufficient distance between the valve pockets. Sufficient material is still present to ensure reliable operation of the internal combustion engine.

It is furthermore provided according to the invention that the piston shaft of the piston has a coating to reduce friction. As a result of this, the friction between cylinder wall and piston, which is already reduced as a result of the structure of the piston with a low overall height, is further reduced. The advantages of this coating are very high durability, outstanding sliding properties and a significant increase in the life span of the piston. The layer thickness of the coating is, for example, approximately 0.01 millimeters (mm). The layer thickness of the coating can be between 0.005 mm and 0.1 mm.

It is furthermore provided according to the invention that the piston has a cooling duct. As a result of this, an effective discharge of the heat generated during combustion is additionally carried out in the case of the piston according to the invention, which is formed as a cooling duct piston, with a low compression height (CH).

It is furthermore provided according to the invention that at least one elongated intake is provided for the admission of oil to the cooling duct. Oil is provided as the cooling medium. As a result of a longer intake, a longer quantity of oil can be stored in the cooling duct. A reservoir for the cooling oil is formed during operation of the internal combustion engine. The level of the cooling oil in the reservoir can be influenced by varying the length of the intake.

It is furthermore provided according to the invention that the cooling duct has molded-in recesses in its contour. As a result of these recesses, the oil or cooling oil can come closer to the wall of the combustion bowl. As a result of this, the exchange of heat between combustion bowl and oil is improved. The transfer of heat, for example, from the combustion bowl to the cooling oil located in the cooling duct is accelerated.

It is furthermore provided according to the invention that the recesses molded into the cooling duct correspond to the position of impact of the focal rays in the combustion bowl. In the case of this arrangement of the recesses in the cooling duct, a direct transmission of the heat quantity introduced by the focal rays into the combustion bowl via the wall of the combustion bowl to the oil is enabled. The heat is discharged close to where it is generated. The piston does not heat up to an unnecessary extent. The life span of the piston is increased as a result of this and the probability of failure for the internal combustion engine, having at least one piston according to the invention, is reduced as a result of this.

It is furthermore provided according to the invention that the upper part is embodied as a warm forged upper part. Warm reshaping of steel is primarily carried out in the temperature range from 650° C. to 900° C. In this range, the yield stress is reduced by more than half in comparison to cold forging in the case of most types of steel. The respectively relevant temperature is dependent on the type of steel, the size of the piston and the number of reshaping steps and is specified in a piston-specific manner lower cost production for the piston in comparison to cold reshaping is achieved by omitting several pressing operations with complex intermediate treatments (intermediate annealing, surface coating) by warm reshaping. Near-net-shape or net-shape reshaped pistons or omitting heat treatment outlay enable low-cost piston production by warm reshaping.

In the case of one possible method for producing a piston for an internal combustion engine, a lower part is joined undetachably by material bonding to an upper part, wherein the lower part comprises a shaft and at least one pin bore and the upper part comprises a combustion bowl and a piston crown with a crown edge, wherein the lower part and the upper part are preferably joined by friction welding. A respective friction weld bead is removed during production of the combustion bowl and the ring part (ring field).

In other words, it is provided in one configuration according to the invention that the dimensions of the finished piston are selected so that the ratio of piston compression height CH and diameter of piston DP ≤0.53. Piston compression height CH is measured from the upper side of the piston, which faces the combustion chamber, in the direction of the center axis of the piston pin. The diameter of the piston DP is the outer diameter of the piston which is ready for operation. Ready for operation means that finishing of the piston has been completed after its manufacture and can be installed in the cylinder of the engine. The outer diameter can be the diameter of the fire land of the piston. Alternatively, the outer diameter of the piston can also be measured in the region of a web between two piston rings. Where applicable, the diameter of a cylindrical or partially cylindrical piston shaft can also be called on to determine the outer diameter of the piston.

The ratio of piston compression height and outer diameter of the piston ≤0.53, preferably <0.53, has the advantage of a particularly compact and reduced-weight design of the piston, combined with reduced overall height and sufficient stability to be able to withstand the stresses during operation in the cylinder of an internal combustion engine.

The use according to the invention of a steel material in combination with the dimensions according to the invention of the piston brings about an optimization of the properties of the arrangement according to the invention during operation of internal combustion engines. The steel material ensures a particularly high level of strength as well as mechanical and thermal load capacity of the piston. The dimensions according to the invention bring about a significant reduction in compression height and a reduction in the mass in comparison to aluminium pistons of, for example, 10% and more. As a result, the moved mass in the arrangement according to the invention is reduced. The dimensions of the piston pin in relation to the piston diameter also represents a very good compromise between the mass of the piston pin and the effective introduction of force from the piston into the piston pin during operation of the internal combustion engine. The reduced mass of the piston pin further noticeably contributes to the reduction of the moved mass in the arrangement according to the invention. The reduction in the overall height or compression height finally leads to an elongation of the connecting rod which results in lower lateral forces and thus reduced frictional forces on the piston shaft or between piston and cylinder running surface during operation of the internal combustion engine.

Pistons with different combustion bowl shapes are used in the case of internal combustion engines. The piston being discussed has a pot combustion bowl. The piston crown is configured so that a squeezing flow (squish flow) is generated in the radial direction between piston edge and cylinder head. Moreover, the swirling flow in the pot combustion bowl is amplified. Piston with pot combustion bowls are very well suited to internal combustion engine with swirl inlet ducts and chamber plugs. During the compression cycle, the mixture is forced over the piston crown edge (squish edge) of the piston into the pot combustion bowl. During the expansion cycle, the mixture is sucked out of the pot combustion bowl again. This operation leads to strong squeezing flows in particular in the vicinity of the upper dead center. In addition to the squeezing flow, the pot combustion bowl also leads to an acceleration of the swirling flow generated on the inlet side. As a result of the maintenance of the angular momentum, the rotational speed of the swirling flow increases if the mixture is forced inwards into the pot combustion bowl. The generation of the squeezing flow and the amplification of the swirling flow have a positive effect on combustion. Recesses in the piston crown which extend into the crown edge enable an improved inflow of the mixture via the valves into the combustion chamber since the piston crown does not hinder inflow.

In the context of consumption and emission reductions in the case of internal combustion engines formed as reciprocating piston machines, progressive developments lead to constantly increasing specific outputs of the reciprocating piston internal combustion engines. This brings with it smaller combustion chambers, in particular cylinders, of the reciprocating piston internal combustion engine, which, in the region of the upper dead center of pistons of the reciprocating piston internal combustion engines, increasingly restrict valve strokes of valves in order to manage changes in gas charge. In order to keep these restrictions of the valve strokes of inlet and outlet valves within limits, a piston according to the invention has for a reciprocating piston internal combustion engine with a ratio of piston compression height and outer diameter of the piston of 0.48 to 0.75, in particular ≤0.53, preferably <0.53, at least one end-side recess, which corresponds to an outer contour of a valve plate of a valve of the reciprocating piston machine and is referred to as a valve pocket in which the valve plate can be received at least in regions. Against the background of constantly increasing peak pressures of such a reciprocating piston machine in combination with temperature fluctuations during internal combustion engine operation thereof, high stresses occur on the piston.

According to a further aspect of the present invention, an internal combustion engine is provided with at least one piston, as described above. This piston of the present invention can be used in any type of reciprocating piston internal combustion engine. The more cylinders and pistons such an internal combustion engine comprises, the greater the effect to be achieved by the invention since the friction of the shaft accounts for a larger ratio of the overall friction there.

According to a further aspect of the present invention, a motor vehicle is provided with one of the internal combustion engines described above. Such a motor vehicle can be embodied, for example, as a land vehicle, as a watercraft or as an aircraft. The most frequent design will relate to land vehicles, for example, cars, commercial vehicles or HGVs.

A further advantage of the low overall height lies in the fact that the internal combustion engine in which the piston is operated can have a flatter design. Combined with the formation of recesses in the piston crown, an even flatter overall height for the piston can be achieved.

### BRIEF DESCRIPTION OF THE DRAWINGS

The fundamental idea is explained below on the basis of the figures. Further details of the invention are described in the figures on the basis of schematically represented exemplary embodiments.

FIG. 1 shows a sectional view of a piston;

FIG. 2 shows a sectional view of a piston according to line II in FIG. 1;

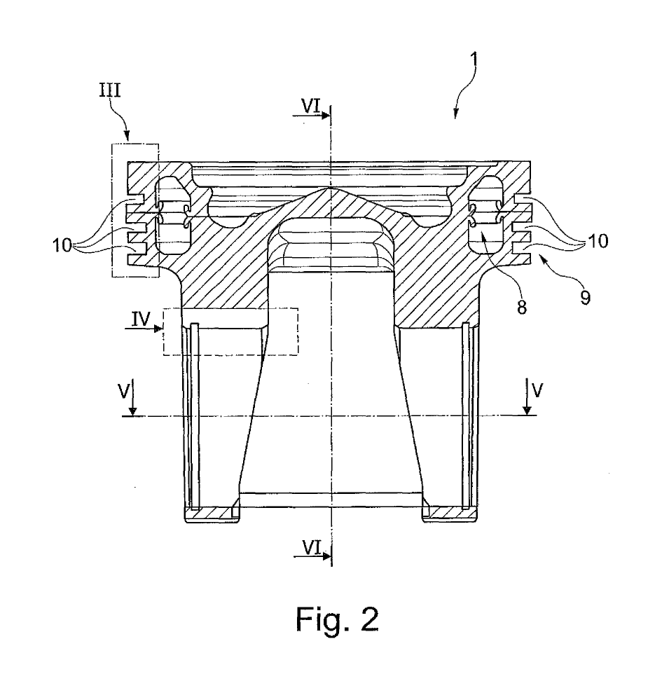

FIG. 3 shows an enlarged detail marked by III in FIG. 2;

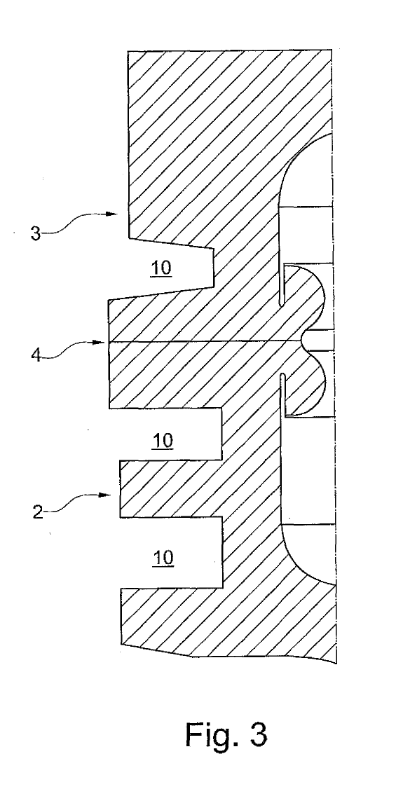

FIG. 4 shows an enlarged detail marked by IV from FIG. 2;

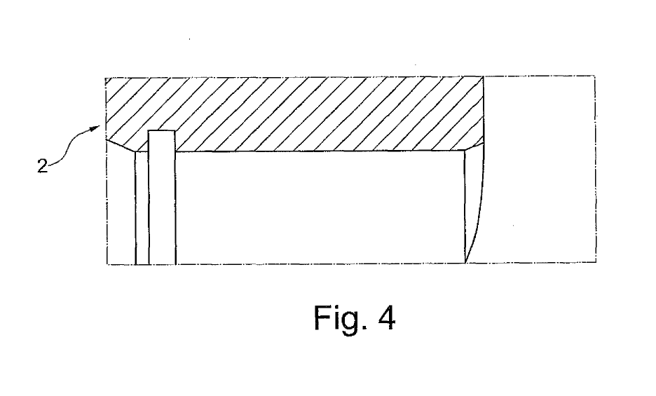

FIG. 5 shows a sectional view of a piston according to line V-V in FIG. 2;

FIG. 6 shows a sectional view of a piston according to line VI-VI in FIG. 2;

FIG. 7 shows a sectional view of a piston according to line VII-VII in FIG. 6;

FIG. 8 shows a sectional view of a piston region according to line VIII-VIII in FIG. 7;

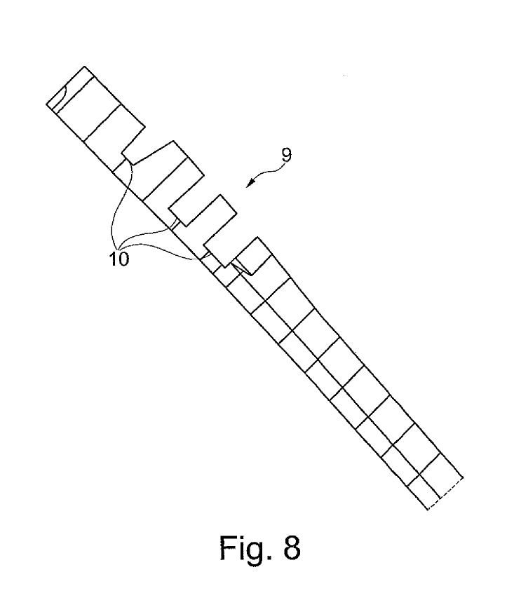

FIG. 9 shows a top view of a piston crown;

FIG. 10 shows a cut-out from the piston in the region of a valve pocket provided on the piston crown side in accordance with a sectional guide X-X in FIG. 9;

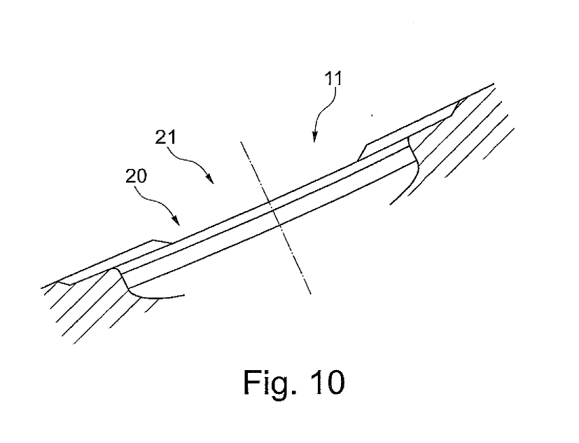

FIG. 11 shows a sectional view of a further piston;

FIGS. 12A and 12B respectively show sectional views of a lower part and an upper part of a piston according to FIG. 11; and

FIGS. 13A and 13B respectively show sectional views rotated by 90 degrees with respect to FIGS. 12A and 12B of a lower part and an upper part of a piston according to FIG. 11.

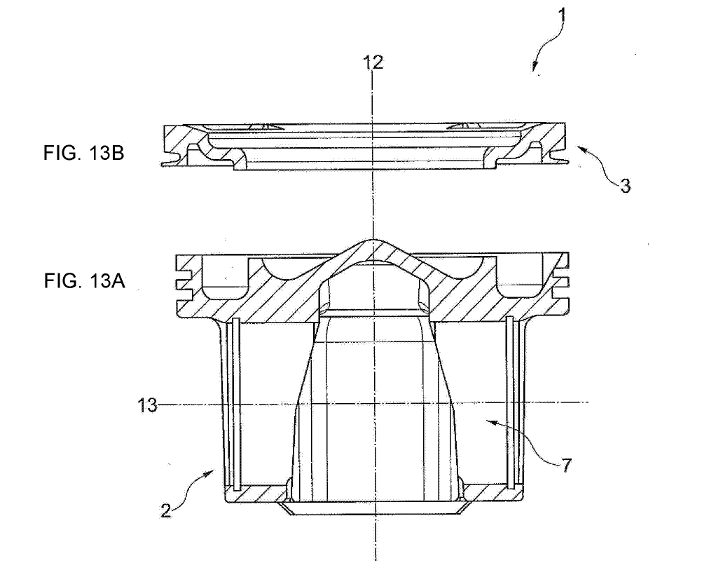

### DETAILED DESCRIPTION

Piston 1 has an identical structure in each case in the Figures and is firstly described in general below. The Figures are subsequently represented in detail in each case. Identical components are designated by identical reference numbers in the Figures and new reference numbers are used in the Figures for different components.

Piston 1 for an internal combustion engine is produced from a lower part 2 and an upper part 3. At least one joint 4 is formed between lower part 2 and upper part 3. Joint surfaces formed on lower part 2 and on upper part 3 meet one another in the region of joint 4. A joint 4 is formed in the region of a ring field 9. A further joint 4 is additionally formed in the outer wall of a combustion bowl 11. At least one of joints 4 can be embodied as a “pipe on plate”. In so far as piston 1 has at least one cooling duct 8, the contour of the at least one cooling duct 8 can be formed in lower part 2 or in upper part 3, wherein this design is referred to as a “pipe”. The mating side is embodied in lower part 2 or in upper part 3 as a circumferential planar or almost planar surface and correspondingly referred to as a “plate”.

A piston crown 5 is formed on upper part 3. Piston crown 5 is arranged on the side of upper part 3 facing away from a cooling duct 8. A piston shaft 6 which has pin bores 7 is formed on lower part 2. Piston 1 joined from lower part 2 and upper part 3 has circumferential ring field 9, equipped with annular grooves 10. Combustion bowl 11 is arranged centrally or eccentrically around a piston stroke axis 12 in upper part 3. There is arranged in the region of pin bore 7 a pin bore axis 13 which corresponds to the center axis of the piston pin, not represented. Oil return openings 19 can be, but do not have to be, arranged in the region of ring field 9.

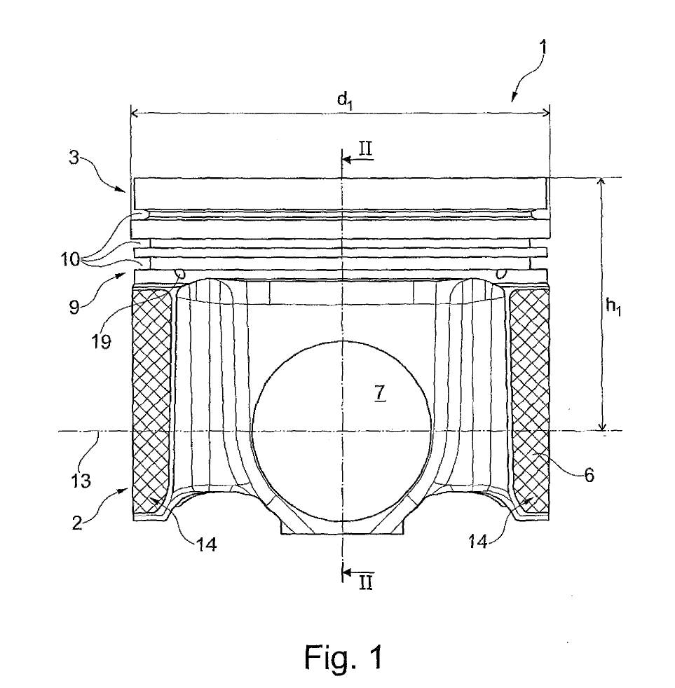

A piston 1 joined from lower part 2 and upper part 2 is depicted in FIG. 1. In the region of shaft 6, this has a coating 14. Said coating 14 has a low degree of friction. The advantages of said coating 14 are very good durability, outstanding sliding properties and a significant increase in the life span of piston 1.

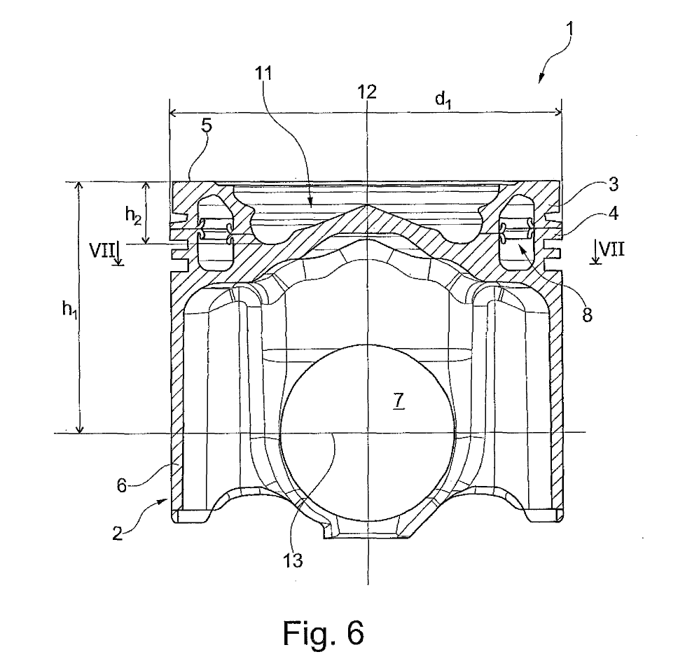

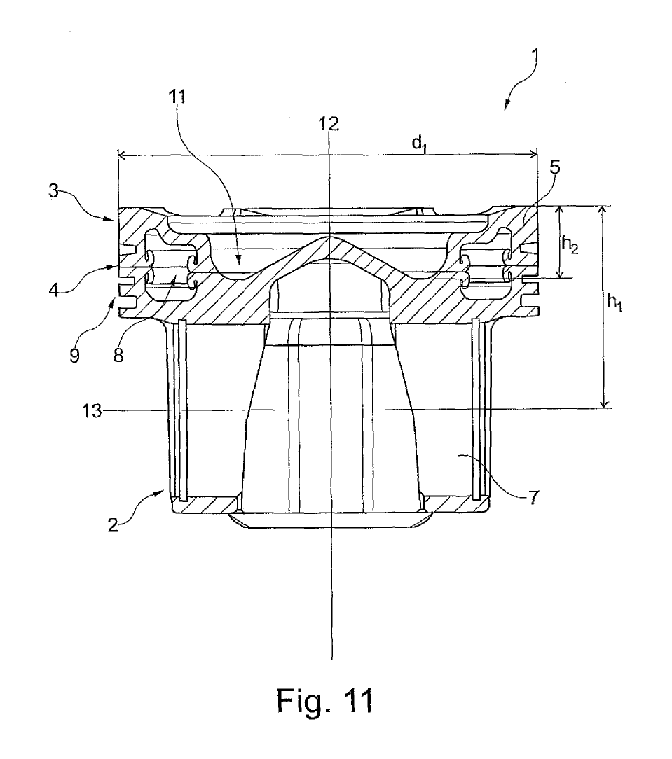

The points at which piston compression height h1 and diameter d1 of the piston are measured are represented in FIGS. 1, 6 and 11. Bowl height h2 of the combustion bowl is plotted in FIGS. 6 and 11. Diameter d1 of piston 1 according to FIGS. 1 and 6 can be, for example, between 100 mm and 150 mm. The value for h1 can vary between 70 mm and 90 mm. The ratio of compression height h1 and diameter d1 of piston 1 thus varies between 0.48 and 0.75.

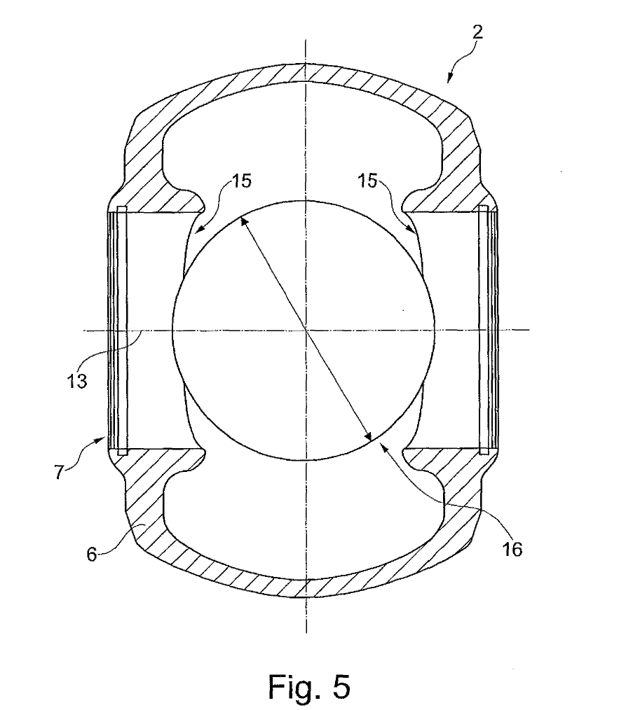

A burr-free region 15 is arranged in the region of pin bore 7 in FIG. 5. An auxiliary counter bore 16 is furthermore represented centrally.

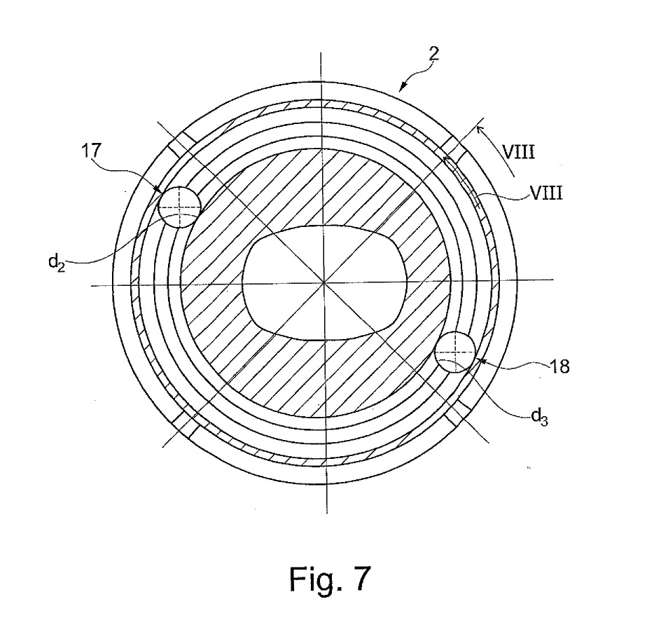

An intake 17 with a diameter d2 and an outlet 18 with a diameter d3 are represented in FIG. 7. Oil can enter into the cooling region through intake 17 and the oil can leave this region again through outlet 18.

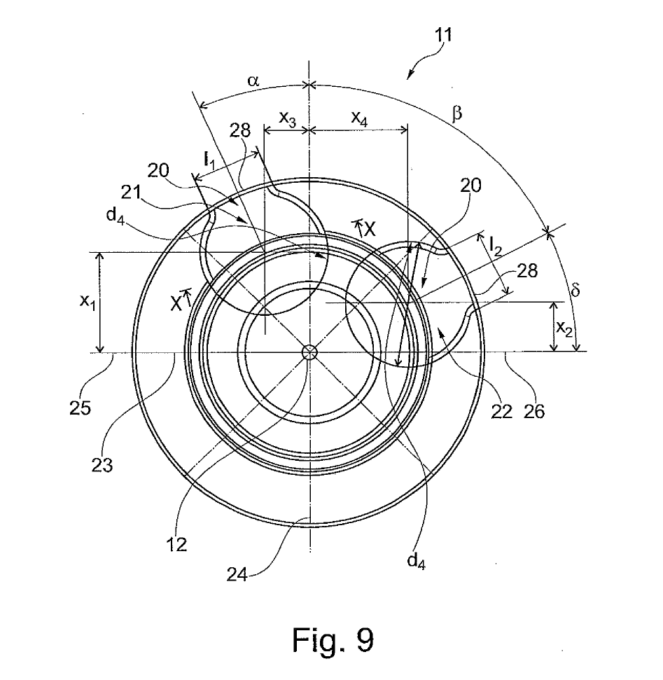

FIG. 9 shows two recesses 20 embodied as valve pockets 21, 22 which each have a diameter d4. Diameter d4 can assume a value between 35 mm and 55 mm. Diameter d4 of valve pockets 21, 22 can also assume different values. Any desired number of recesses 20, which are formed, for example, as milled slots, can be provided. At least a part of recesses 20 is preferably formed at least in regions as valve pocket 21, 22, in which gas exchange valves of the reciprocating piston internal combustion engine can be accommodated at least in regions, i.e. dip in, during their operation. A collision of the gas exchange valves with piston 1 can thus be avoided. As a result of this configuration and function of recesses 20, a functional integration is represented which keeps the costs of piston 1, in particular its production costs, low.

Valve pockets 21, 22 of piston 1 follow on in the radial direction of piston 1, in which valve pockets respective corresponding valve plates of gas exchange valve of the reciprocating piston internal combustion engine can be received. If piston 1 is located at its upper dead center in the combustion chamber of the reciprocating piston machine, valve pockets 21, 22 provide enough space for the respective gas exchange valves, i.e. for corresponding inlet and outlet valves, so that the gas exchange valves can respectively carry out a desirably large valve stroke in order to enable a gas exchange. In other words, the gas exchange valves can open wide enough by means of the spaces provided by valve pockets 21, 22 in order to be able to efficiently bring about an exchange of exhaust gas and air taken in by the reciprocating piston internal combustion engine or a mixture taken in by the reciprocating piston internal combustion engine.

A first circular segment Alpha is located between a first valve pocket 21 and line 24 which is perpendicular to line 23 which connects a pressure side (PS) 25 and a counter-pressure side (CPS) 26. A second circular segment Beta is located between line 24 which is perpendicular to line 23 which connects pressure side 25 and counter-pressure side 26 and a second valve pocket 22. A third circular segment Gamma is located between second valve pocket 22 and line 23 which connects pressure side 25 and counter-pressure side 26. The first circular segment Alpha can assume values between 15 degrees and 30 degrees, preferably between 20 degrees and 25 degrees. The second circular segment Beta can assume values between 55 degrees and 70 degrees, preferably between 60 degrees and 65 degrees. The third circular segment Gamma can assume values between 15 degrees and 35 degrees, preferably between 20 degrees and 30 degrees.

Piston crown 11 is bounded circumferentially by crown edge 27. Crown edge 27 has, in the region of valve pockets 21, 22, a clearance or circular segment-shaped recesses 28. Length I1 of recess 28 of first valve pocket 21 corresponds to length I2 of recess 28 of second valve pocket 22. Lengths I1 and I2 can assume values between 15 millimeters and 35 millimeters, preferably between 20 mm and 30 mm. According to the exemplary embodiment, I1 and I2 can have identical values, but do not have to have identical values. The dimensions for I1 and I2 can be varied independently of one another.

Distance x1 between line 23 and the center point of first valve pocket 21 is larger than distance x2 between line 23 and the center point of second valve pocket 22. Distance x1 can be between 30 mm and 45 mm, preferably between 35 mm and 40 mm. Distance x2 can lie between 15 mm and 22.5 mm, preferably between 17.5 mm and 22.5 mm.

The distance between the center point of first valve pocket 21 and line 24 is designated by x3. The distance between line 24 and the center point of second valve pocket 22 is designated by x4. Distance x3 is smaller than distance x4. Distance x4 can lie between 25 mm and 45 mm, preferably between 30 mm and 40 mm. Distance x3 can lie between 12.5 mm and 22.5 mm, preferably between 15 mm and 20 mm.

FIG. 11 shows a finished piston 1, in which it is apparent at which points piston compression height h1 and diameter d1 of the piston are measured. Piston 1 shown in FIG. 11 is a two-part piston, comprising upper part 3 and lower part 2 which are joined together. Ready for use, piston 1 is then integral. However, piston 1 can also be formed in one piece. Said piston 1 has a ratio between compression height h1 of piston 1 and diameter d1 of piston 1 of ≤0.53.

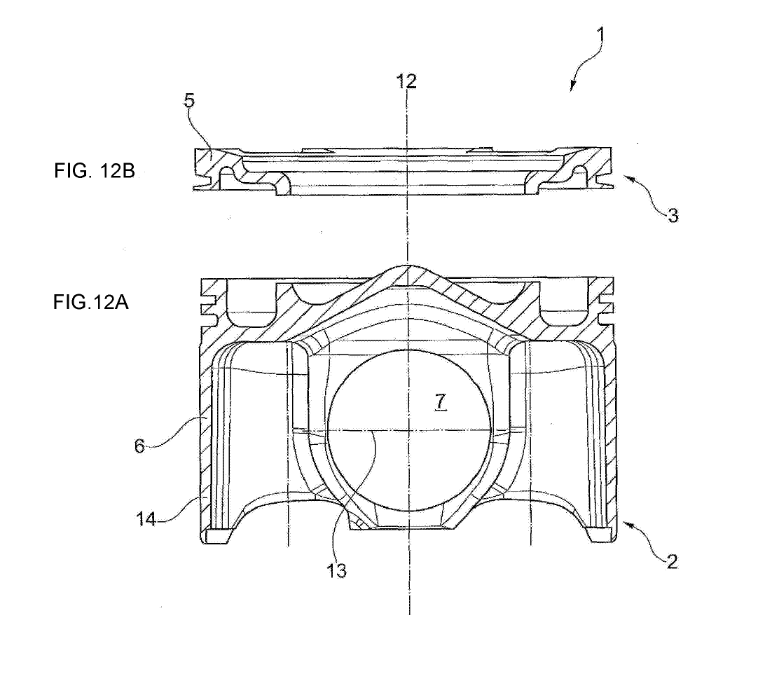

FIGS. 12A and 12B as well as 13A and 13B show the views of upper part 3 and lower part 2 prior to joining together. This is an example of a constructive configuration of upper part 3 and lower part 2 which are joined together in a suitable manner, preferably by friction welding in order to achieve the desired ratio ≤0.53, preferably less than 0.53.

### LIST OF REFERENCE NUMBERS

1 Piston
2 Piston lower part
3 Piston upper part
4 Joint
5 Piston crown
6 Piston shaft
7 Pin bore
8 Cooling duct
9 Ring field
10 Annular groove
11 Combustion bowl
12 Piston stroke axis
13 Pin bore axis/center axis of the pin bore
14 Coating
15 Burr-free region
16 Auxiliary counter bore
17 Intake
18 Outlet
19 Oil return opening
20 Recess
21 First valve pocket
22 Second valve pocket
23 Line between pressure side (PS) and counter-pressure side (CPS)
24 Line perpendicular to line 23
25 Pressure side (PS)
26 Counter-pressure side (CPS)
27 Crown edge
28 Clearances
h₁ Piston compression height
h₂ Bowl height
l₁ Length of the clearance of the first valve pocket
l₂ Length of the clearance of the second valve pocket
x₁ Distance between line 23 and the center point of first valve pocket 21
x₂ Distance between line 23 and the center point of second valve pocket 22
x₃ Distance between the center point of first valve pocket 21 and line 24
x₄ Distance between line 24 and the center point of second valve pocket 22
d₁ Diameter of piston
d₂ Diameter of intake
d₃ Diameter of outlet
d₄ Diameter of valve pocket
Alpha first circular segment between first valve pocket and the line which is perpendicular to the line which connects the pressure side and the counter-pressure side
Beta second circular segment between the line which is perpendicular to the line which connects the pressure side and the counter-pressure side and the second valve pocket
Gamma third circular segment between the second valve pocket and the line which connects the pressure side and the counter-pressure side

1. A piston for an internal combustion engine, having an upper part joined by material bonding to a lower part, wherein the lower part comprises a shaft and at least one pin bore, wherein the upper part comprises a combustion bowl and a piston crown having a crown edge, characterized in that at least one joint is arranged in a region of a ring field and in an outer wall of the combustion bowl and a ratio of piston compression height (h₁) and diameter of the piston (d₁) is smaller than 0.53.

2. The piston of claim 1, wherein the joint in the outer wall of the combustion bowl is positioned above a finished combustion bowl base in a direction of a piston stroke axis.

3. The piston of claim 1, wherein the piston crown defines at least one recess.

4. The piston of claim 3, wherein the at least one recess defines at least one clearance which passes at least partially through the crown edge of the piston crown.

5. The piston of claim 3, wherein the at least one clearance is configured in a circular segment shape.

6. The piston of claim 3, wherein the at least one recess defines a first valve pocket.

7. The piston of claim 6 wherein the at least one recess defines a second valve pocket, wherein a distance (x₁) between a line positioned between a pressure side and counter-pressure side and a center point of the first valve pocket is larger than a distance (x₂) between the line and a center point of the second valve pocket.

8. The piston of claim 7, wherein the distance (x₁) is at least twice as large as the distance (x₂).

9. The piston of claim 1 further comprising a coating positioned on the piston shaft, the coating operable to reduce friction.

10. The piston of claim 1 further comprising a cooling duct.

11. The piston of claim 10, further comprising at least one elongated intake in communication with the cooling duct operable to provide the admission of oil to the cooling duct.

12. The piston of claim 11, wherein the cooling duct defines at least one molded-in recess in a cooling duct contour.

13. The piston of claim 12, wherein the at least one molded-in recess in the cooling duct is positioned at a point of impact of focal rays in the combustion bowl.

14. The piston of claim 1 wherein the upper part comprises a warm forged upper part.

15. A piston for an internal combustion engine comprising:
a lower part having a shaft defining at least one pin bore having a pin bore axis, the lower part oriented along a piston stroke axis perpendicular to the pin bore axis;
an upper part connected to the lower part at a joint, the upper part further having a top surface and defining a combustion bowl recess extending from the top surface toward the lower part;
the connected upper part and lower part further comprising:
a ring field extending radially from and longitudinally along the piston stroke axis, the joint positioned in the ring field;
a piston compression height (h1) defined between the pin bore axis and the upper part top surface;
a piston outer diameter (d1);
wherein a ratio of the piston compression height (h1) and the piston outer diameter (d1) is between 0.48 and 0.75.

16. The piston of claim 15 wherein the ratio of the piston compression height (h1) and the piston outer diameter (d1) is less than 0.53.

17. The piston of claim 16, wherein the piston compression height (h1) is between 70 millimeters and 90 millimeters, and the piston outer diameter (d1) is between 100 millimeters and 150 millimeters.

18. The piston of claim 15 wherein the upper part further defines a first recess in the top surface and extending toward the lower part.

19. The piston of claim 18 wherein the upper part further defines a first valve pocket positioned within the first recess.

20. The piston of claim 19, wherein:
the recess defines a clearance positioned through an outer edge of the upper part top surface; and
the first valve pocket includes a diameter (d4) between 35 millimeters and 55 millimeters.
